(19) United States
(12) Patent Application Publication
(10) Pub. No.: US 2022/0292584 A1
(43) Pub. Date: Sep. 15, 2022

(54) COMBINING DATA AND NOTIFICATIONS FOR MULTIPLE ACCOUNTS OF A COMMON USER

(71) Applicant: salesforce.com, inc., San Francisco, CA (US)

(72) Inventors: Rajeev Shimoga Kumar, Deerfield Beach, FL (US); Fan Liu, Boca Raton, FL (US)

(21) Appl. No.: 17/198,317

(22) Filed: Mar. 11, 2021

(51) Int. Cl. G06Q 30/06; G06Q 10/08; H04L 9/32

(52) U.S. Cl. CPC G06Q 30/0637; G06Q 10/0833; H04L 9/3213

(57) ABSTRACT

Methods, computer readable media, and devices for securely managing interactions between distributed components are provided. One method may include creating a consolidated order account for a user, receiving information corresponding to a first retailer account of the user, retrieving a first order status of the first order from the first retailer account of the user, the first order status, receiving information corresponding to a second retailer account of the user, retrieving a second order status of the second order from the second retailer account of the user, presenting the first order status and the second order status to the user via the consolidated order account, and providing the user an option to receive details corresponding to the first order status and the second order status via the consolidated order account.

### TECHNICAL FIELD

Embodiments disclosed herein relate to techniques and systems for combining data and status notifications across multiple user accounts that relate to a common user, where the different accounts may be associated with different remote providers. Embodiments disclosed herein may be used to reduce redundancy in user records, improve user experiences when managing multiple accounts, and to consolidate management of orders or other data from multiple sources for a user.

### BACKGROUND

In a traditional approach, a shopper may have a different account for each retailer and may need to visit each retailer individually to check the status of various orders. Alternatively, the shopper may have to search through various emails to find necessary information.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a system for consolidated order management according to some example implementations.

FIG. 1B illustrates a sample consolidated order account presentation according to some example implementations.

FIGS. 1C-1E illustrate sample schemas for a consolidated order account according to some example implementations.

FIG. 2 is a flow diagram illustrating a method for use of a consolidated order account according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Ordering products from a retailer by a consumer has become commonplace. A shopper may create an online account with retailer A, place an order with retailer A, and track the order, typically via a portal provided by retailer A. However, when the shopper places an order with retailer B, the shopper may have to repeat this process, resulting in two distinct accounts with the two retailers. In order to check a status of each order, the shopper may need to log into their account with retailer A and separately log into their account with retailer B. As such, order management by the shopper has become very difficult. Implementations disclosed herein may address such difficulties by providing a consolidated order account for the user.

In various implementations, order management by a user may be improved by creating a consolidated order account that is able to retrieve information about various orders from various retailers. For example, a shopper may purchase a pair of shoes from retailer A, a pair of sandals from retailer B, and a pair of sunglasses from retailer C. Instead of logging back into each retailer's account portal or digging through emails, the shopper may log into a consolidated order account portal. The consolidated order account portal may, for example, retrieve order information from retailer A, order information from retailer B, and order information from retailer C. Once the shopper logs into the consolidated order account portal, the shopper may be able to view information for all of the orders.

In various implementations, various different retailers may utilize a common electronic commerce (e-commerce) platform provided by a separate third-party. This e-commerce platform may provide or otherwise support, for example, the various components involved in a retail shopping experience. For example, the e-commerce platform may provide a store-front (e.g., web pages for presenting items for sale and hosting for those web pages), checkout functionality, inventory management, order management, a user account portal, and the like.

In various implementations, the third-party provider of the e-commerce platform may also provide a consolidated order account portal. For example, the third-party provider may enable a user to create a consolidated order account and register or otherwise provide information about the user and/or the user's accounts with various retailers. The provided information may include, for example, an email address of the user used to place an order with a retailer. Alternatively, or in addition, the information may include, for example, an authentication token associated with an account of the user at a retailer. Based on the provided information, the third-party provider may be able to retrieve order information for the user from the various different retailers. For example, the third-party provider may utilize the user's email address to query each of the various retailers to retrieve order information. Alternatively, or in addition, the third-party provider may utilize the authentication token to connect with the retailer and retrieve order information.

By providing a consolidated order account and consolidated order account portal, the third-party provider may enable a shopper to more easily manage various orders from various retailers. Such management may include, for example, information about an order (e.g., date order placed, amount of order, retailer, etc.), a status of an order (e.g., placed, fulfilled, shipped, completed, etc.) and a link to tracking information for an order. Such management may also include, for example, an ability to connect to a retailer of an order (e.g., a link to retailer's account portal).

Implementations of the disclosed subject matter provide methods, computer readable media, and devices for a consolidated order account. In various implementations, a method may include creating, by a server, a consolidated order account for a user, receiving, by the server, information corresponding to a first retailer account of the user, where the first retailer account of the user is an account created for the user at a first retailer from which the user has placed a first order, and the information comprises an identification of the first retailer and a first identification of the user for access to the first retailer account of the user, retrieving, by the server, a first order status of the first order from the first retailer account of the user, the first order status may be including: an order identifier; the identification of the retailer; a status of the order; a date the order was placed; and a total amount of the order, receiving information corresponding to a second retailer account of the user, the second retailer account of the user being an account created for the user at a second retailer different from the first retailer from which the user has placed a second order, retrieving a second order status of the second order from the second retailer account of the user, presenting the first order status and the second order status to the user via the consolidated order account, and providing the user an option to receive details corresponding to the first order status and the second order status via the consolidated order account.

In various implementations, a first identification of the user for access to the first retailer of the user may include a username of the user for the first retailer account.

In various implementations, a first identification of the user for access to the first retailer account of the user may include an authentication token, the authentication token enabling access to the first retailer account. In some implementations, the authentication token may include a hash received by the server from the first retailer, the hash generated based on a username of the user for the first retailer account and a password of the user for the first retailer account.

In various implementations, retrieving a first order status of the first order from the first retailer account of the user may include utilizing an application programming interface (API) provided by the first retailer account.

In various implementations, the first order status may further include a first tracking identifier of the first order, the second order status may include a second tracking identifier of the second order, and providing the user an option to receive details corresponding to the first order status and the second order status may include providing a first universal resource locator (URL) link based on the first tracking identifier and a second URL link based on the second tracking identifier to the user.

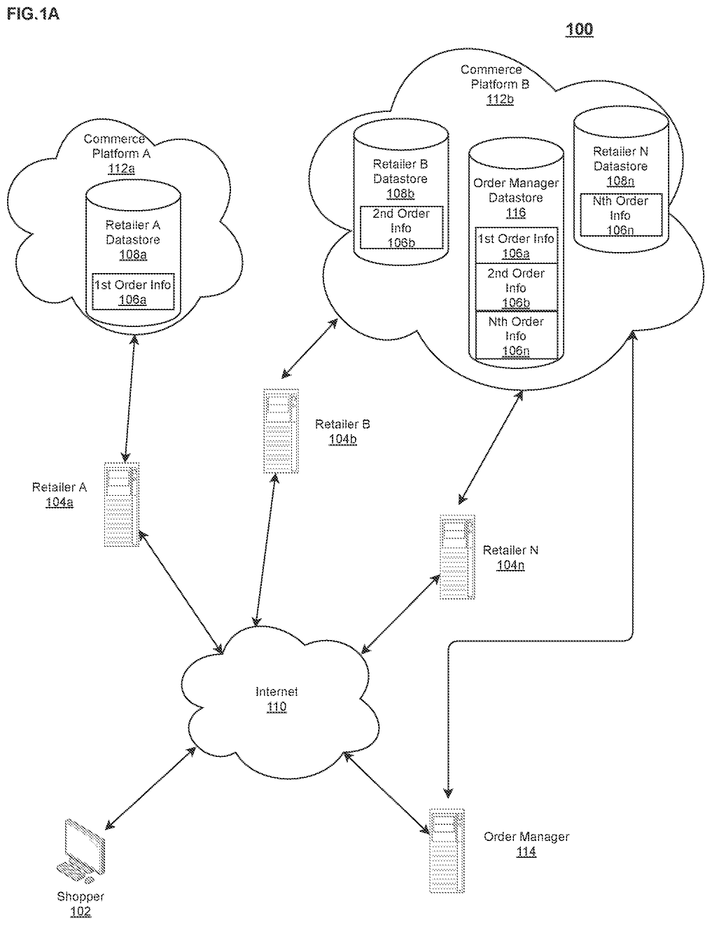

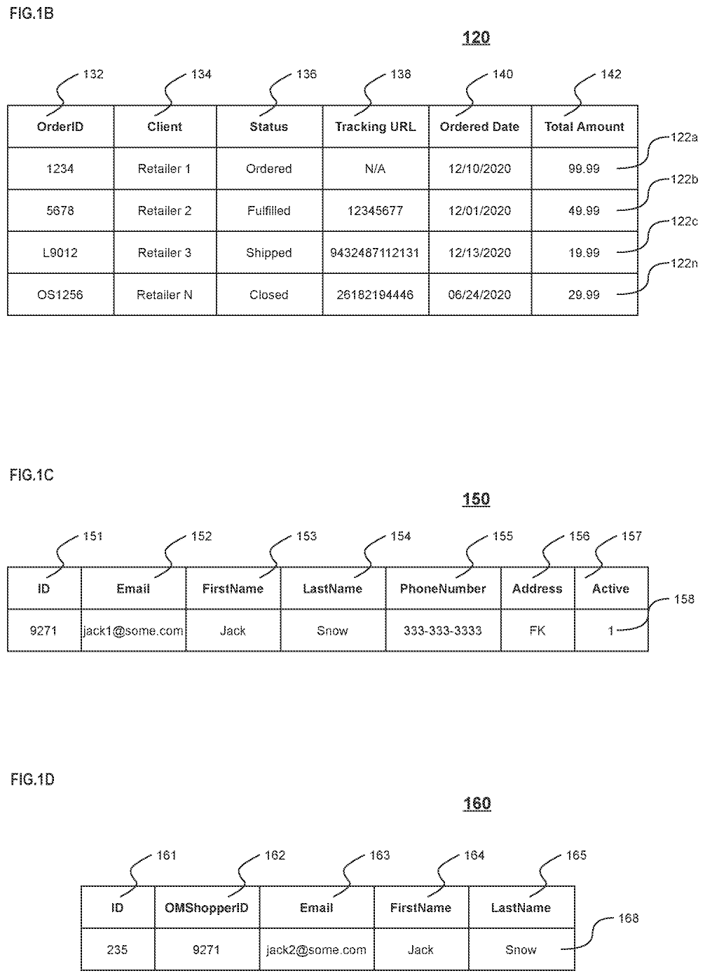

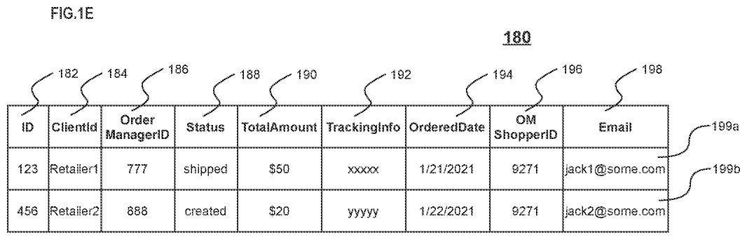

FIG. 1A illustrates a system 100 for use with consolidated order management according to some example implementations. In various implementations, system 100 may include a shopper 102, a plurality of retailers A-N 104a . . . n, commerce platform A 112a, commerce platform B 112b, and an order manager 114. Although a single shopper is shown, this is only for simplicity. Similarly, while only three retailers and two commerce platforms are shown, this is only for simplicity.

In various implementations, retailer A 104a may utilize a third-party commerce platform, such as commerce platform A 112a. Such third-party commerce platform may provide, for example, infrastructure and resources necessary to enable retailer A 104a to offer an online retail shopping experience. For example, commerce platform A 104a may provide various services such as a store-front environment, order management, inventory management, customer account management, and the like. In particular, commerce platform A 104a may include, for example, retailer A datastore 108a. Retailer A datastore 108a may be, for example, a database or other data store that provides storage of order information, such as 1^{st} order info 106a.

In various implementations, retailer B 104b and retailer N 104n may utilize a third-party commerce platform, such as commerce platform B 112b. Commerce platform B 112b may be provided, for example, by a different third-party than commerce platform A 112a. Alternatively, the same third-party may, for example, provide both commerce platform A 112a and commerce platform B 112b. Commerce platform B 112b may provide, for example, infrastructure and resources necessary to enable retailer B 104b and retailer N 104n to offer an online retail shopping experience. The infrastructure and resources provided by commerce platform B 112b may be similar to those provided by commerce platform A 112a. Alternatively, the infrastructure and resources provided by one commerce platform may be different from those provided by the other commerce platform (e.g., commerce platform A 112a may offer additional services while commerce platform B 112b offers fewer services). While commerce platform B 112b may provide, for example, similar services to both retailer B 104b and retailer N 104n, commerce platform B 112b may provide, for example, different services to each retailer. Commerce platform B 112b may include, for example, retailer B datastore 108b and retailer N datastore 108n. Retailer B datastore 108b may be, for example, a database or other data store that provides storage of order information, such as 2^{nd} order info 106b. Similarly, retailer N datastore 108n may be, for example, a database or other data store that provides storage of order information, such as Nth order info 106n.

In various implementations, order manager 114 may also utilize, for example, commerce platform B 112b. Order manager 114 may, for example, be operated or otherwise provided by the same third-party that operates or otherwise provides commerce platform B 112b. In these examples, commerce platform B 112b may include order manager datastore 116. Order manager datastore 116 may be, for example, a database or other data store that provides storage of consolidated order information, such as 1^{st} order info 106a, 2^{nd} order info 106b, and Nth order info 106n.

In various implementations, shopper 102 may, for example, visit each of the retailers and place an order for goods and/or services. For example, shopper 102 may visit retailer A 104a and place a first order, resulting in 1^{st} order info 106a. Subsequently, shopper 102 may, for example, visit retailer B 104b to place a second order resulting in 2^{nd} order info 106b and visit retailer N 104n to place a Nth order resulting in Nth order info 106n.

In various implementations, order manager 114 may, for example, consolidate information about the various orders into a consolidated account, such as via order manager datastore 116. For example, order manager 114 may retrieve 1^{st} order info 106a from retailer A datastore 108a, 2^{nd} order info 106b from retailer B datastore 108b, and Nth order info 106n from retailer N datastore 108n. As discussed in greater detail below, order manager 114 may be able to retrieve the various order information based on common information shared by order manager 114 and the various retailers, such as a user's email address. Alternatively, or in addition, order manager 114 may be able to retrieve the various order information based on an authentication token for each retailer. For example, shopper 102 may request or otherwise prompt retailer A 104a to generate an authentication token, such as a hash of the username and password of shopper 102 for retailer A 104a. In turn, shopper 102 may provide such authentication token to order manager 114. Order manager 114 may, for example, perform such consolidation of order information on a recurring basis. For example, order manager 114 may retrieve order information once a week, once a day, once an hour, or the like. Alternatively, or in addition, order manager 114 may retrieve order information as a result of shopper 102 requesting such retrieval. For example, shopper 102 may click an update button or otherwise request that order manager retrieve information.

Shopper 102 may be able to visit, for example, order manager 114 to view 1^{st} order info 106a, 2^{nd} order info 106b, and Nth order info 106n without needing to revisit each of the various retailers. This may facilitate improved order management by shopper 102.

FIG. 1B illustrates a sample consolidated order account presentation 120 that may be provided to a user, such as via a consolidated order account portal. For example, once a user logs into a consolidated order account portal such as one provided by order manager 114 of FIG. 1A, the user may be presented with consolidated order account presentation 120. In various implementations, information provided may include an orderID 132, a client 134, a status 136, a tracking URL 138, an ordered date 140, and a total amount 142. OrderID 132 may represent, for example, an identifier of an order, such as an identifier assigned by a retailer when an order is placed with the retailer. Client 134, may represent, for example, a retailer with which an order was placed. Status 136 may represent, for example, a status of an order. Tracking URL 138 may represent, for example, a link to tracking information for an order, if such link is available. Ordered date 140 may represent, for example, a date an order was placed. Total amount 142 may represent, for example, a total amount of an order. In various implementations, order information may be presented in tabular form. For example, as shown in FIG. 1B, four orders 122a . . . n may have been placed and the associated order information may be presented with each line corresponding to a different order.

FIG. 1C illustrates a sample order manager shopper schema 150 according to some example implementations. In various implementations, each entry within an order manager shopper schema 150 may include, for example, an ID field 151, an email field 152, a firstname field 153, a lastname field 154, a phonenumber field 155, an address field 156, and an active field 157. For example, entry 158 includes an ID field with a value of 9271, an email field with a value of jack1@some.com, a firstname field with a value of Jack, a lastname field with a value of Snow, a phonenumber field with a value of 333-333-3333, an address field with a value of FK, and an active field with a value of 1. Based on this example, the shopper Jack Snow has an ID of 9271 and an associated email of jack1@some.com.

FIG. 1D illustrates a sample order manager alias schema 160 according to some example implementations. In various implementations, a shopper utilizing a consolidated order manager as described herein may use more than one email address when placing orders. For example, a shopper may use a first email address when placing an order with a first retailer and a second email address when placing an order with a second retailer. As such, the shopper may register multiple email addresses with the consolidated order manager. Order manager alias schema 160 may include, for example, an ID field 161, an OMShopperID field 162, an email field 163, a firstname field 164, and a lastname field 165. For example, entry 168 includes an ID field with a value of 235, an OMShopperID field with a value of 9271, an email field with a value of jack2@some.com, a firstname field with a value of Jack, and a lastname field with a value of Snow. In this example, the OMShopperID value of 9271 may relate back to the ID field of entry 158 of FIG. 1C, thus associating the additional email address of jack2@some.com with the shopper Jack Snow and the original email address of jack1@some.com.

In various implementations, a consolidated order manager, such as order manager 114 of FIG. 1A, may utilize the email address field of order manager shopper schema 150 and/or the email address field of order manager alias schema 160 in order to retrieve order information from one or more of the various retailers. For example, the consolidated order manager may present or otherwise submit email addresses for a shopper contained in the order manager shopper schema 150 and/or the order manager alias schema 160 to a retailer and the retailer may provide any order information associated with those email addresses.

FIG. 1E illustrates a sample order manager order schema 180 according to some example implementations. In various implementations, each entry within an order manager order schema 180 may include, for example, an ID field 182, a clientID field 184, an ordermanagerID field 186, a status field 188, a totalamount field 190, a trackinginfo field 192, an ordereddate field 194, an OMShopperID field 196, and an email field 198. In various implementations, information from entries within order manager order schema 180 may be utilized to provide information for a consolidated order account presentation, such as consolidated order account presentation 120 of FIG. 1B. As shown in FIG. 1E, two order entries 199a, 199b are associated with a shopper having an order manager ID of 9271 and email addresses of jack1@some.com and jack2@some.com.

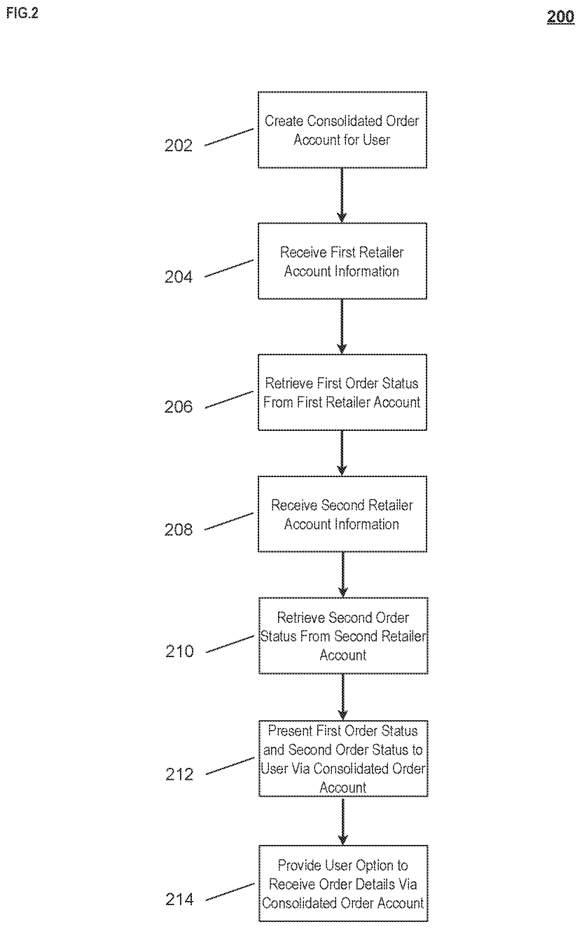

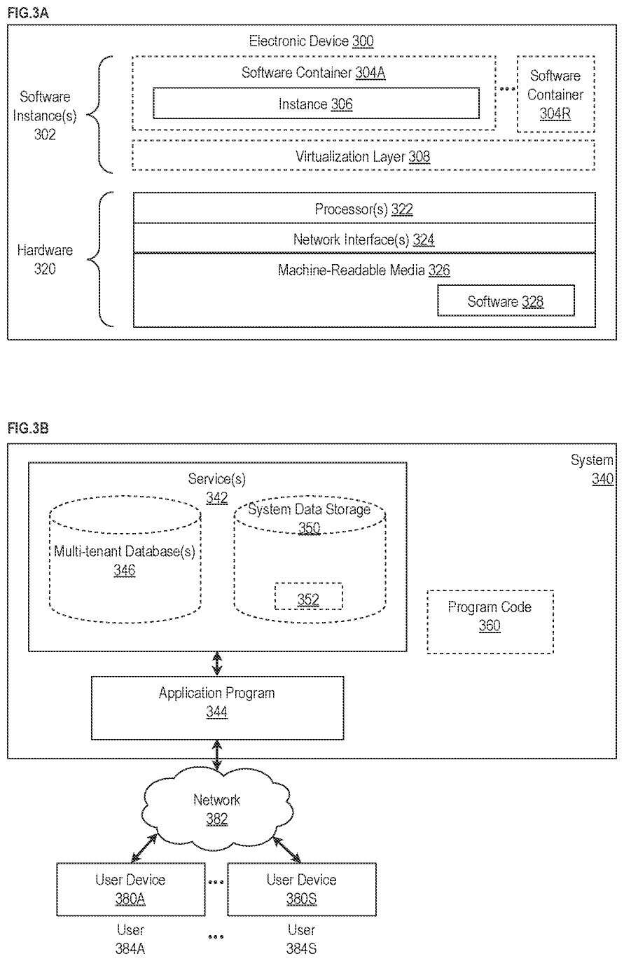

FIG. 2 illustrates a method 200 for utilizing a consolidated order manager, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In step 202, a consolidated order account may be created for a user. For example, a user may register with a consolidated order manager, such as order manager 114 of FIG. 1A. As part of the registration, the user may provide, for example, information about the user, such as a name, an address, a phone number, an email address, and the like. The user, as part of the registration process or after completing registration, may provide or otherwise select, for example, information about one or more retailers from which the user has placed an order and/or plans to place an order. For example, the user may input or select from a list a name of a retailer.

In step 204, account information of a first retailer may be received. In various implementations, the account information may include, for example, an email address associated with the retailer (e.g., a user registered the email address as part of registration with the retailer or used the email address when placing an order with the retailer), an authentication token associated with the retailer, a user identification associated with the retailer, or the like. Such account information may have been provided, for example, when a user registered with a consolidated order manager (e.g., as part of step 202) or sometime after creating the account. In this case, the first retailer account information may be received from a datastore or storage of a consolidated order manager. Alternatively, or in addition, the first retailer account information may be received, for example, by prompting the user to enter the information.

In various implementations, receiving first retailer account information may, for example, involve creating such account information. For example, a user may be prompted to visit or otherwise interact with the first retailer in order to create an authentication token, which is then received as the first retailer account information. In some implementations, an authentication token may be generated, for example, by creating a hash of a user's username and password associated with a user's account of the retailer.

In step 206, first order status may be retrieved from the first retailer account. In various implementations, retrieval of order status may be based on or otherwise associated with the first retailer account information received in step 204. For example, an authentication token may be presented or otherwise utilized to retrieve order status information from a retailer. In another example, an email address may be presented or otherwise utilized to retrieve the order status information.

In some implementations, a third-party that provides services to both the first retailer and the consolidated order manager may, for example, utilize, based on accepted and secure criteria, common access to datastores of both the first retailer and the consolidated order manager in order to retrieve the first order status. For example, the third-party may perform a query on a datastore of the first retailer to retrieve the order status information and then store the retrieved information in a datastore of the consolidated order manager.

In some implementations, an application programming interface (API) may be utilized to retrieve the first order status from the first retailer. For example, a consolidated order manager may utilize, for example, an API exposed or otherwise offered by the first retailer to retrieve the order information. Alternatively, or in addition, a consolidated order manger may expose or otherwise offer an API and a retailer may utilize such API to provide order status.

In various implementations, first order status may include, for example, information about or otherwise associated with a first order previously placed with the first retailer. Such information may include, for example, an order identifier, an order status (e.g., ordered, fulfilled, shipped, etc.), tracking information (e.g., a tracking URL), a total amount, and the like.

In step 208, account information of a second retailer may be received. As discussed above in relation to step 204, such account information may have been previously provided and may be retrieved from memory or a user may be prompted to provide such account information as part of step 208. While second retailer account information may be similar or of the same type as first retailer account information (e.g., first retailer account information may be an email address and second retailer account information may be an email address), second retailer account information may be of a different type (e.g., first retailer account information may be an email address and second retailer account information may be an authentication token). In addition, even if first retailer account information and second retailer account information are of the same type (e.g., both email addresses), such account information may not be the same (e.g., a first email address for first retailer account information and a second email address for second retailer account information).

In step 210, second order status may be retrieved from the second retailer account. For example, second retailer account information may be utilized to retrieve second order status from the second retailer account. As in step 206, order status may be retrieved, for example, via an API and/or based on common access to separate datastores. In various implementations, second order status may include, for example, information about or otherwise associated with a second order previously placed with the second retailer.

In step 212, first order status and second order status may be presented to a user via the consolidated order account. For example, first order status and second order status may be presented in a form such as the consolidated order account presentation 120 of FIG. 1B.

In step 214, an option to receive order details via the consolidated order account may be provided to the user. For example, first order status and/or second order status may include tracking information, such as a tracking identifier or code, and the option to receive order details may be a link, such as a link to a shipper's website where detailed tracking information for an order may be provided.

Although method 200 of FIG. 2 only involves two retailers and a single order from each retailer, this is only for simplicity. For example, step 206 (or step 210) may be repeatedly performed or otherwise expanded to retrieve multiple order statuses from a first retailer (or a second retailer) and all of the order statuses may be presented as part of step 212. Similarly, steps 204 and 206 (or steps 208 and 210) may be repeatedly performed for any number of retailers from which a user may have placed an order.

As disclosed herein, a consolidated order manager and a consolidated order account may facilitate improved order management by a user. Instead of visiting multiple retailers and/or searching through past emails, a user may visit the consolidated order account of the consolidated order manager and see information about the various orders in one place.

In addition to improving the user experience as disclosed herein, various implementations also may improve the efficiency and operation of the retail or other commercial sites that a user may access when managing multiple orders. For example, the user of a consolidated account may reduce the amount of data that individual commerce sites need to transmit to each user for what may be very simple interactions, such as checking an order status. Instead of providing an entire web page or other interface to the user in each case, the commerce site may provide only the status information to a system that manages the consolidated order account. Alternatively, or in addition, some commerce sites may be directly connected to the consolidated account such that no additional communications are needed. As another example, where multiple commerce sites are hosted by a common service provider such as a commerce platform, the commerce platform may provide APIs or other interfaces for the sites to provide status updates or other information without requiring direct user interaction, thereby reducing the communication, storage, and bandwidth requirements for not only the individual commerce sites but also the commerce platform as a whole.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method comprising:
creating, by a server, a consolidated order account for a user;
receiving, by the server, information corresponding to a first retailer account of the user, where:
the first retailer account of the user is an account created for the user at a first retailer from which the user has placed a first order; and
the information comprises an identification of the first retailer and a first identification of the user for access to the first retailer account of the user;
retrieving, by the server, a first order status of the first order from the first retailer account of the user, the first order status comprising:
an order identifier;
the identification of the retailer;
a status of the order;
a date the order was placed; and
a total amount of the order;
receiving information corresponding to a second retailer account of the user, the second retailer account of the user being an account created for the user at a second retailer different from the first retailer from which the user has placed a second order;
retrieving a second order status of the second order from the second retailer account of the user;
presenting the first order status and the second order status to the user via the consolidated order account; and
providing the user an option to receive details corresponding to the first order status and the second order status via the consolidated order account.

2. The computer-implemented method of claim 1, wherein a first identification of the user for access to the first retailer of the user comprises a username of the user for the first retailer account.

3. The computer-implemented method of claim 1, wherein a first identification of the user for access to the first retailer account of the user comprises an authentication token, the authentication token enabling access to the first retailer account.

4. The computer-implemented method of claim 3, wherein the authentication token comprises a hash received by the server from the first retailer, the hash generated based on a username of the user for the first retailer account and a password of the user for the first retailer account.

5. The computer-implemented method of claim 1, wherein retrieving a first order status of the first order from the first retailer account of the user comprises utilizing an application programming interface (API) provided by the first retailer account.

6. The computer-implemented method of claim 1, wherein:
the first order status further comprises a first tracking identifier of the first order;
the second order status comprises a second tracking identifier of the second order; and
providing the user an option to receive details corresponding to the first order status and the second order status comprises providing a first universal resource locator (URL) link based on the first tracking identifier and a second URL link based on the second tracking identifier to the user.

7. A non-transitory machine-readable storage medium that provides instructions that, if executed by a processor, are configurable to cause the processor to perform operations comprising:
creating, by a server, a consolidated order account for a user;
receiving, by the server, information corresponding to a first retailer account of the user, where:
the first retailer account of the user is an account created for the user at a first retailer from which the user has placed a first order; and
the information comprises an identification of the first retailer and a first identification of the user for access to the first retailer account of the user;
retrieving, by the server, a first order status of the first order from the first retailer account of the user, the first order status comprising:
an order identifier;
the identification of the retailer;
a status of the order;
a date the order was placed; and
a total amount of the order;
receiving information corresponding to a second retailer account of the user, the second retailer account of the user being an account created for the user at a second retailer different from the first retailer from which the user has placed a second order;
retrieving a second order status of the second order from the second retailer account of the user;
presenting the first order status and the second order status to the user via the consolidated order account; and
providing the user an option to receive details corresponding to the first order status and the second order status via the consolidated order account.

8. The non-transitory machine-readable storage medium of claim 7, wherein a first identification of the user for access to the first retailer of the user comprises a username of the user for the first retailer account.

9. The non-transitory machine-readable storage medium of claim 7, wherein a first identification of the user for access to the first retailer account of the user comprises an authentication token, the authentication token enabling access to the first retailer account.

10. The non-transitory machine-readable storage medium of claim 9, wherein the authentication token comprises a hash received by the server from the first retailer, the hash generated based on a username of the user for the first retailer account and a password of the user for the first retailer account.

11. The non-transitory machine-readable storage medium of claim 7, wherein retrieving a first order status of the first order from the first retailer account of the user comprises utilizing an application programming interface (API) provided by the first retailer account.

12. The non-transitory machine-readable storage medium of claim 7, wherein:
the first order status further comprises a first tracking identifier of the first order;
the second order status comprises a second tracking identifier of the second order; and
the instructions are further configurable to cause the processor to perform further operations comprising providing the user an option to receive details corresponding to the first order status and the second order status comprises providing a first universal resource locator (URL) link based on the first tracking identifier and a second URL link based on the second tracking identifier to the user.

13. An apparatus comprising:
a processor; and
a non-transitory machine-readable storage medium that provides instructions that, if executed by the processor, are configurable to cause the apparatus to perform operations comprising:
creating, by a server, a consolidated order account for a user;
receiving, by the server, information corresponding to a first retailer account of the user, where:
the first retailer account of the user is an account created for the user at a first retailer from which the user has placed a first order; and
the information comprises an identification of the first retailer and a first identification of the user for access to the first retailer account of the user;
retrieving, by the server, a first order status of the first order from the first retailer account of the user, the first order status comprising:
an order identifier;
the identification of the retailer;
a status of the order;
a date the order was placed; and
a total amount of the order;
receiving information corresponding to a second retailer account of the user, the second retailer account of the user being an account created for the user at a second retailer different from the first retailer from which the user has placed a second order;
retrieving a second order status of the second order from the second retailer account of the user;
presenting the first order status and the second order status to the user via the consolidated order account; and
providing the user an option to receive details corresponding to the first order status and the second order status via the consolidated order account.

14. The apparatus of claim 13, wherein a first identification of the user for access to the first retailer of the user comprises a username of the user for the first retailer account.

15. The apparatus of claim 13, wherein a first identification of the user for access to the first retailer account of the user comprises an authentication token, the authentication token enabling access to the first retailer account.

16. The apparatus of claim 15, wherein the authentication token comprises a hash received by the server from the first retailer, the hash generated based on a username of the user for the first retailer account and a password of the user for the first retailer account.

17. The apparatus of claim 13, wherein retrieving a first order status of the first order from the first retailer account of the user comprises utilizing an application programming interface (API) provided by the first retailer account.

18. The apparatus of claim 13, wherein:
the first order status further comprises a first tracking identifier of the first order;
the second order status comprises a second tracking identifier of the second order; and
the instructions are further configurable to cause the processor to perform further operations comprising providing the user an option to receive details corresponding to the first order status and the second order status comprises providing a first universal resource locator (URL) link based on the first tracking identifier and a second URL link based on the second tracking identifier to the user.
